(19) United States
(12) Patent Application Publication
(10) Pub. No.: US 2008/0288668 A1
(43) Pub. Date: Nov. 20, 2008

(54) COMMUNICATION METHOD

(75) Inventors: Axel Lohbeck, Minden (DE); Wolfgang Jantzen, Minden (DE); Gerd Dewitz, Bad Salzuflen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/107,869

(22) Filed: Apr. 23, 2008

(30) Foreign Application Priority Data
Apr. 23, 2007 (DE) 10 2007 019 049.4

(51) Int. Cl. G06F 3/00

(52) U.S. Cl. 710/11

(57) ABSTRACT

The disclosure relates to a method and system for communication between modular devices for measurement, closed-loop and open-loop control. It is proposed that the communication-carrying bus physics and the USB protocol be used for data transmission between modules.

### RELATED APPLICATION

This application claims priority under 35 U.S.C. §119 to German Patent Application No. 10 2007 019 049.4 filed in Germany on Apr. 23, 2007, the entire content of which is hereby incorporated by reference in its entirety.

### TECHNICAL FIELD

A method and system for communication between modular devices for measurement are disclosed, closed-loop and open-loop control.

### BACKGROUND INFORMATION

DE 42 38 957 discloses a modular device whose modules are connected to one another for communication purposes by means of a plurality of serial lateral buses, which are routed in parallel, and are in the form of CAN buses.

The progressive development of devices for measurement, closed-loop and open-loop control has led to increasing volumes of data, as a result of better monitoring and diagnostic functions in particular, the transport and transmission of which volumes of data within reasonable time periods overloads even multiple bus configurations, and at the same time leads to large amounts of material being required.

### SUMMARY

A method for communication between modular devices for measurement is disclosed, closed-loop and open-loop control, which allows a high data throughput with little use of material.

A modular device for measurement is disclosed, closed-loop and open-loop control, whose modules are connected to one another by means of serial buses, for communication.

A method for communication between modular devices for measurement, closed-loop and open-loop control is disclosed, wherein communication-carrying bus physics and USB protocol are used for data transmission.

A system for communication is disclosed. An exemplary system comprises modular devices for measurement based on modules; and closed-loop and open-loop control, wherein a communication-carrying bus based on USB protocol is used for data transmission.

### BRIEF DESCRIPTION OF THE DRAWINGS

Further details and advantages of the disclosure will be described in the following text with reference to exemplary embodiments. In the drawings which are required for this purpose:

FIG. 1 shows an outline illustration of a modular device with a coupling element in a module,

FIG. 2 shows an outline illustration of a modular device with an infrastructure coupling element, and

FIG. 3 shows an outline illustration of a modular device with modules which are connected by means of a two-wire line.

### DETAILED DESCRIPTION

According to the disclosure, the universal serial bus (USB) is used for the communication-carrying bus physics and for the protocol for these series buses. This includes, for example, differential transmission of the data via a pair of conductors and point-to-point connection between in each case two modules.

Appropriate communication circuits for USB operation are commercially available. Because of the widespread use of USB in the field of personal computers, these communication circuits are manufactured in large quantities, and therefore cost little in comparison to communication circuits of other less widely used bus systems. Furthermore, the software drivers for operation of the communication circuits are available for the various operating systems. The complexity for implementation of the communication means is therefore advantageously low.

Since Version 2.0 of the USB specification, the data rate on the bus is up to 480 MBit/s. This data rate can also actually be used by virtue of the point-to-point connection between in each case two modules, since collisions caused by other subscribers whose wish to transmit on the same bus are precluded in the master-slave mode. In this case, there is no need for measures for addressing the subscribers and for collision resolution.

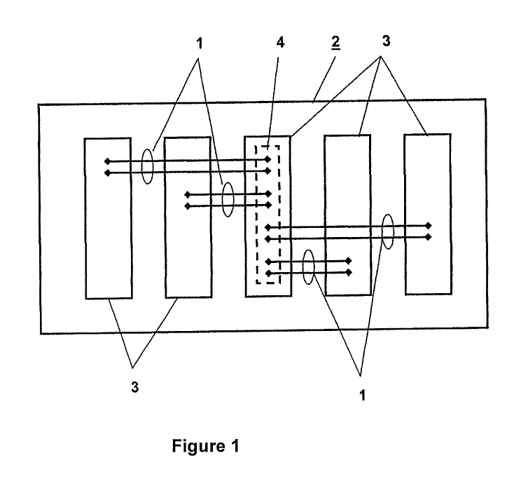

A first exemplary embodiment of the disclosure as shown in FIG. 1 provides for the USB to be used on a pair of conductors 1 on a backplane printed circuit board 2. A backplane printed circuit board 2 such as this is provided and is suitable for communication connection of a plurality of modules 3 of a device for measurement, closed-loop and open-loop control. In this case, the modules 3 are each connected to one another in pairs by means of a point-to-point connection. Each module 3 for this purpose has at least one interface for connection of a pair of conductors 1, which carry the USB.

Furthermore, a coupling element 4 is provided for connection of all the point-to-point connections. This coupling element 4 has a plurality of interfaces for connection of pairs of conductors 1 which carry the USB and can be connected to one another. This coupling element 4 may be a component of the module 3, as shown in the illustration in FIG. 1.

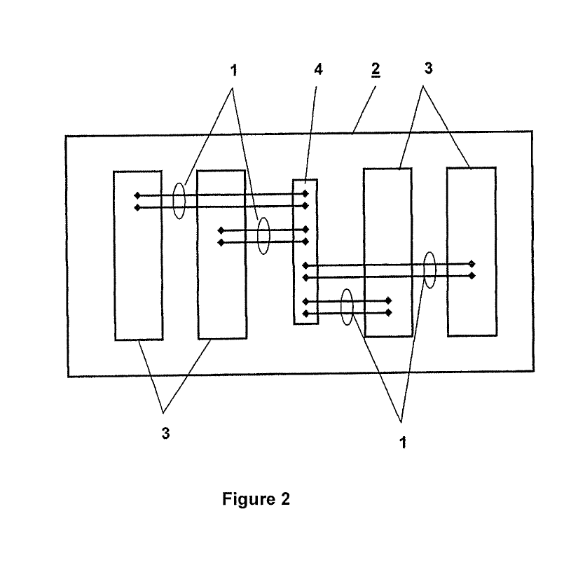

Alternatively, as shown in the illustration in FIG. 2, and using the same reference symbols for the same items, this coupling element 4 can be arranged on the backplane printed circuit board 2.

The parallelity of a plurality of point-to-point connections which are linked to one another can result in a higher data throughput overall via the bus system and via a single bus.

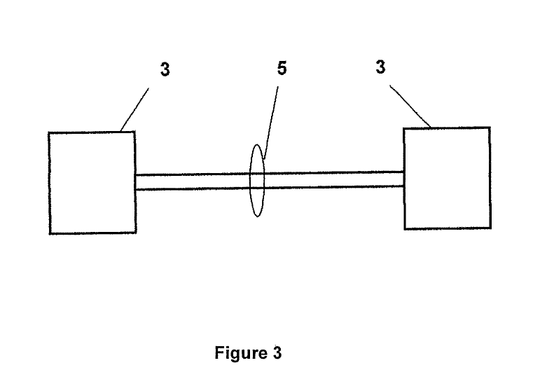

In a second exemplary embodiment of the disclosure, as illustrated in FIG. 3, the USB is used on a two-wire line 5 between the modules 3 of the modular devices. In this case, a first, remote module 3 is connected via a two-wire line 5 to a second module 3, with the USB signal being transmitted on this two-wire line 5. The USB protocol can make it possible to disconnect and connect the two communication subscribers 3 during operation.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pair of conductors
2 Backplane printed circuit board
3 Module
4 Coupling element
5 Two-wire line

What is claimed is:

1. A method for communication between modular devices for measurement, closed-loop and open-loop control, wherein
communication-carrying bus physics and USB protocol are used for data transmission.

2. The method as claimed in claim 1, wherein
the USB is used on a pair of conductors on a backplane printed circuit board.

3. The method as claimed in claim 1, wherein
the USB is used on a two-wire line between the modules of the modular devices.

4. A system for communication, comprising:
modular devices for measurement based on modules; and
closed-loop and open-loop control, wherein
a communication-carrying bus based on USB protocol is used for data transmission.

5. The system as claimed in claim 4, wherein
the USB protocol is used on a pair of conductors on a backplane printed circuit board.

6. The system as claimed in claim 4, wherein
the USB protocol is used on a two-wire line between the modules of the modular devices.
